(19) United States
(12) Patent Application Publication
(10) Pub. No.: US 2015/0033268 A1
(43) Pub. Date: Jan. 29, 2015

(54) CONTENT MANAGEMENT SYSTEMS, METHODS, APPARATUS AND USER INTERFACES

(71) Applicant: TRANSCITY GROUP PTY LTD, Scoresby, Victoria (AU)

(72) Inventors: James Alford, Bellevue, WA (US); David McNair, Toolern Vale (AU)

(73) Assignee: TRANSCITY GROUP PTY LTD, Scoresby, Victory (AU)

(21) Appl. No.: 14/347,926

(22) PCT Filed: Sep. 28, 2012
(86) PCT No.: PCT/US2012/001195

§ 371 Date: Mar. 27, 2014

(30) Foreign Application Priority Data
Sep. 28, 2011 (AU) 2011903999

(51) Int. Cl. H04N 21/472; H04N 21/422; H04N 21/434; H04N 21/462; H04N 21/643

(52) U.S. Cl. CPC H04N 21/47202; H04N 21/4622; H04N 21/64322; H04N 21/4347; H04N 21/42206
USPC 725/54

(57) ABSTRACT

The invention generally relates to content management systems, methods, apparatus and user interfaces for transmitting, displaying and enabling the manipulation of content from multiple sources. In one embodiment, a system for managing content supplied from a plurality of sources in respective signals includes a server for transmitting a multicast stream comprising streams representing the signals from the plurality of sources and one or more apparatus coupled to be in communication with, the server and subscribing to the multicast stream. Each apparatus includes a plurality of player objects, each of which is paired with a constituent stream of the multicast stream. The apparatus also comprises at least one viewing object coupled with one of the player objects to display content from the stream paired with the respective player object.

### FIELD OF THE INVENTION

The present invention relates to content management systems, methods, apparatus and user interfaces. In particular, the present invention relates to systems, methods, apparatus and user interfaces for transmitting, displaying and enabling the manipulation of content from multiple sources.

### BACKGROUND TO THE INVENTION

Internet Protocol television (IPTV) is a system through which audio and visual content are delivered to end users typically using the TCP/IP protocol over a packet-switched network such as the Internet, instead of being delivered through conventional channels, such as free to air, satellite and cable television. One example of its use is in the hospitality sector, such as in hotels and bars. In a hotel room for example, a user can access live free to air television, which can include interactivity related to the program being shown, replays of television shows, video on demand (VOD), satellite and/or cable channels as well as radio channels and content including, for example, information about the hotel or city in which the hotel is located.

In an IPTV system, signals from multiple sources, such as those described above, are received by a modulator at the venue which combines the multiple signals into a modulated signal. The modulated RF signal comprising the multiple signals is transmitted to an IPTV server, which multicasts the signals to multiple receivers at the venue, typically via one or more routers. The signal displayed by the receiver, such as an LCD screen depends on the channel selected. This system uses transcoding as required to convert the signal formats for display purposes and to reduce bandwidth requirements.

One problem with the aforementioned system is the time lag or latency experienced when switching between channels, which can typically be several seconds or more. This occurs because of the “handshaking” required to synchronize the receiver with the IPTV server. In a bar environment particularly, such delays in switching between channels impairs the user experience. In addition to users missing sections of the content during switching, the accumulated lost time is time that could have been used, for example, for advertising and therefore the accumulated lost time represents potentially lost revenue.

Another problem with the aforementioned system, particularly in a bar environment, is the lack of interactivity in such systems. For example, a venue typically comprises multiple screens displaying different channels and content, but users are limited to merely watching and listening to the content. Also, users tend to all face in the same direction watching the screen, which often results in reduced interaction between the users rendering such systems somewhat antisocial. Furthermore, if users want to watch another channel, but stay in the same area of the venue, users must ask a staff member to change the channel. Additionally, this can often be met with disagreement from some users who want to continue to watch the same channel in the same area of the venue. Yet further, venues are always looking to attract more customers and increase their turnover and profit.

### OBJECT OF THE INVENTION

It is a preferred object of the present invention to provide a system and/or a method and/or an apparatus and/or a user interface that addresses or at least ameliorates one or more of the aforementioned problems of the prior art.

### SUMMARY OF THE INVENTION

Generally, embodiments of the present invention relate to systems, methods, apparatus and user interfaces for transmitting, displaying and enabling the manipulation of content from multiple sources which enable multiple channels from different sources to be viewed simultaneously and which enable switching between channels with reduced latency compared with the prior art.

According to one aspect, but not necessarily the broadest aspect, the invention resides in a method for managing content supplied from a plurality of sources in respective signals, the method including:

splitting a multicast stream comprising a plurality of streams representing the signals into the constituent streams;

pairing a player object with each constituent stream; and

coupling a viewing object with one of the player objects to display content from the stream paired with the respective player object.

Preferably, the method further includes switching a stream displayed by the viewing object by coupling the viewing object with a different player object.

Suitably, the method includes transcoding one or more of the signals and/or resizing content prior to combining the signals into the multicast stream.

According to another aspect, but not necessarily the broadest aspect, the invention resides in an apparatus for managing content supplied from a plurality of sources in a multicast stream, the apparatus including:

a plurality of player objects, each player object paired with a constituent stream of the multicast stream; and

at least one viewing object coupled with one of the player objects to display content from the stream paired with the respective player object.

Suitably, the apparatus includes a plurality of viewing objects capable of simultaneously displaying content from a stream paired with the respective player object with which the viewing object is coupled.

Suitably, the apparatus is in the form of a tabletop display, a bar top display, a desk top display or a display tablet.

Suitably, the apparatus comprises one or more input devices, such as a touch screen, a keyboard, a controller, a card reader, a bank note acceptor, a coin acceptor, a barcode scanner, a ticket scanner or other virtual or physical input device.

Suitably, the apparatus comprises one or more output devices, such as a printer.

According to a further aspect, but not necessarily the broadest aspect, the invention resides in a system for managing content supplied from a plurality of sources in respective signals, the system including:

a server for transmitting a multicast stream comprising streams representing the signals from the plurality of sources;

one or more apparatus coupled to be in communication with the server and subscribing to the multicast stream;

wherein each apparatus includes:
a plurality of player objects, each player object paired with a constituent stream of the multicast stream; and
at least one viewing object coupled with one of the player objects to display content from the stream paired with the respective player object.

Suitably, the server is an IPTV server.

Suitably, the system further includes a master control server coupled to be in communication with the server via a communications network.

Suitably, the system further includes a content management module coupled to be in communication with the server, preferably via the master control server, to provide additional content to the apparatus.

According to a yet further aspect, but not necessarily the broadest aspect, the invention resides in a graphical user interface for displaying content supplied from a plurality of sources in a multicast stream, the interface including:

at least one viewing object coupled with one of a plurality of player objects to display content from the player object, each player object paired with one of the streams in the multicast stream;

at least one user input field to receive input from a user to couple the at least one viewing object to a different player object to cause the viewing object to display content from a stream paired with the different player object.

Preferably, the interface includes a plurality of viewing objects.

Preferably, the interface includes at least one field for displaying information relating to content displayed by the at least one viewing object, such as performance statistics and/or betting odds relating to a sports event displayed by the at least one viewing object.

Further aspects and features of the present invention will become apparent from the following detailed description.

### BRIEF DESCRIPTION OF THE DRAWINGS

In order that the invention may be readily understood and put into practical effect, reference will now be made to embodiments of the present invention with reference to the accompanying drawings, wherein like reference numbers refer to identical elements. The drawings are provided by way of example only, wherein:

FIG. 1 is a schematic diagram of a system for managing content supplied from a plurality of sources in accordance with embodiments of the present invention;

FIG. 2 is a schematic diagram illustrating embodiments of the system, method and apparatus of the present invention;

FIG. 3 is a schematic diagram illustrating a graphical user interface according to embodiments of the present invention;

FIG. 3A is a schematic diagram illustrating a graphical user interface according to other embodiments of the present invention; and

FIG. 4 is a general flow diagram illustrating methods according to embodiments of the present invention.

Skilled addressees will appreciate that elements in the drawings are illustrated for simplicity and clarity and have not necessarily been drawn to scale. For example, the relative dimensions of some of the elements in the drawings may be distorted to help improve understanding of embodiments of the present invention.

### DETAILED DESCRIPTION OF THE INVENTION

Embodiments of the present invention will be described with reference to systems, methods, apparatus and user interfaces for transmitting, displaying and enabling the manipulation of content from multiple sources which enable multiple channels from different sources to be viewed simultaneously and which enable switching between channels with at least reduced, if not negligible latency compared with the prior art.

In this specification, references will be made to communications between various elements via one or more communications networks. In some embodiments, the communications network is the Internet. However, the present invention is not limited to communications via the Internet and the use of other communications networks is envisaged, such as, but not limited to one or more of public communications networks, private communications networks, local area networks (LANs), wide area networks (WANs), management area networks (MANs), intranets, extranets or any combination thereof as are known to the skilled addressee and which can be implemented via known wired and/or wireless communication means.

It should also be appreciated that in this specification, references to content refer to any type of content, such as, but not limited to audio, video, still images, text, graphics or any combination thereof. Consequently, references herein to displaying content include the playing of audio.

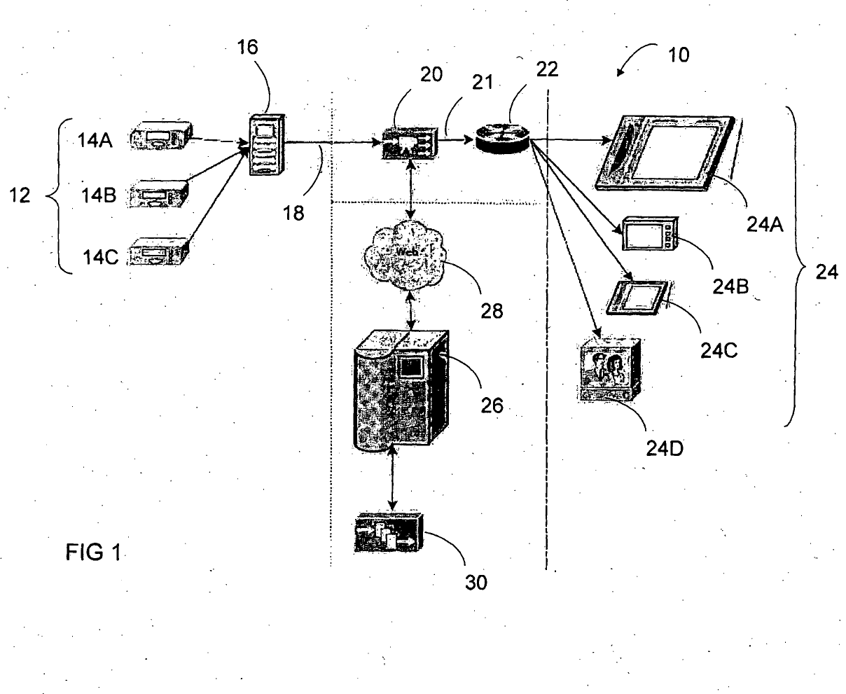

With reference to FIG. 1 and in accordance with one aspect, embodiments of the present invention reside in a system 10 for managing content supplied from a plurality of sources 12, such as, but not limited to free to air television, video on demand (VOD), satellite television, cable television, in-house television, radio channels, web browser content, such as content from a specific website and static content, e.g. from a specific file. A dedicated receiver 14A, 14B, 14C, such as a “set top box”, is required to receive each respective signal from the plurality of sources 12.

As in conventional systems, signals from the receivers 14A, 14B, 14C are received by a modulator 16, for example at the venue, which combines the multiple signals into a modulated signal 18. The modulated RF signal 18 comprising the multiple signals is transmitted to a server 20, such as an IPTV server. If required, the server 20 transcodes one or more of the signals, for example, from MPEG2 format to MPEG4 format as is known in the art. The server 20 can also resize content to suit the final output. Both transcoding and resizing reduce the amount of data and thus the bandwidth required. The server 20 combines the signals into a multicast stream 21 and transmits the multicast stream comprising streams representing the signals from the plurality of sources, typically via one or more routers 22.

The system 10 includes one or more apparatus 24 coupled to be in communication with the server 20. Each apparatus subscribes to and receives the multicast stream 21 transmitted by the server 20. As described in further detail hereinafter, each apparatus 24 includes a plurality of player objects and at least one viewing object. Each player object is paired with a constituent stream of the multicast stream 21. The at least one viewing object is coupled with one of the player objects to display content from the stream paired with the respective player object.

As will be described in further detail hereinafter, apparatus 24 can be in the form of a tabletop display 24A, a bar top or desk top display 24B, a display tablet 24C or a conventional IPTV receiver 24D.

Whilst the modulator 16 and server 20 are shown as separate elements in FIG. 1, according to some embodiments, the modulator 16 and server 20 can be incorporated in apparatus 24.

According to some embodiments, the system 10 includes a master control server 26 coupled to be in communication with the server 20 via a communications network 28, such as, but not limited to the Internet.

According to some embodiments, the system 10 includes a content management module 30 coupled to be in communication with the server 20, preferably via the master control server 26, to provide additional content to the apparatus 24. In some embodiments, the additional content can relate to the venue in which embodiments of the present invention is implemented, such as information relating to goods and/or services provided in the venue.

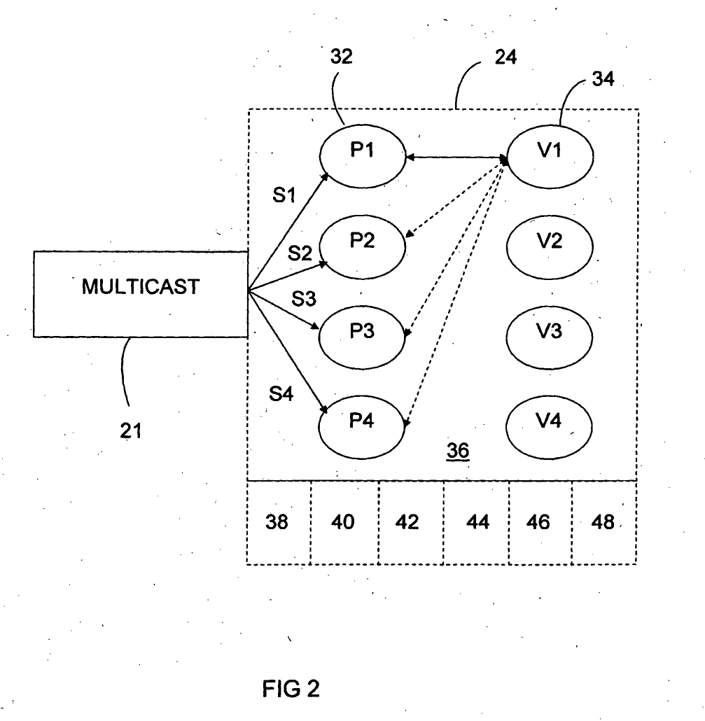

With reference to FIG. 2, and in accordance with another aspect, embodiments of the present invention reside in an apparatus 24 for managing content supplied from a plurality of sources 12 in a multicast stream 21. Apparatus 24 includes a plurality of player objects 32 implemented in software. Each player object 32 is paired with a constituent stream of the multicast stream 21. In the example shown in FIG. 2, apparatus 24 comprises four player objects 32 in the form of player objects P1, P2, P3 and P4 each linked with a respective stream S1, S2, S3, S4 of the multicast stream 21.

Apparatus 24 includes at least one viewing object 34 implemented in software coupled with one of the player objects 32 to display content from the stream paired with the respective player object. In the example shown in FIG. 2, apparatus 24 includes four viewing objects 34 in the form of viewing objects V1, V2, V3 and V4. Viewing object V1 is coupled with player object V1 to display content from stream S1 paired with player object V1.

To switch the stream displayed by the viewing object V1, the viewing object V1 is coupled with a different player object, such as P2, P3 or P4, to display the respective streams S2, S3, S4 paired with the respective player object. In doing so, viewing object V1 is decoupled from playing object P1.

Player objects 32 act as a pseudo channel or proxy between the server 20 and the viewing object 34 with which the player object is coupled. Player objects 32 manage the view of the stream content and are independent of the viewing area in use by the apparatus 24. Viewing objects 34 manage parameters concerned with displaying the content and switching between streams S1, S2, . . . of the multicast stream 21. Switching between streams involves switching between player objects 32 and because each player object 32 is always paired with a particular stream of the multicast stream 21, switching between streams minimizes, if not avoids the latency associated with switching channels as experienced with prior art systems.

According to some embodiments, apparatus 24 includes a plurality of viewing objects 34, such as the four viewing objects V1-V4 shown in FIG. 2. Multiple viewing objects 34 are capable of simultaneously displaying content from respective player objects 32 with which the viewing objects 34 are coupled. The content displayed by the viewing objects 34 depends on the stream paired with the respective player object 34. For the sake of clarity, FIG. 2 only shows viewing object V1 coupled to player object P1 represented by the solid arrow with the option of switching to player objects P2-P4 represented by the dotted arrows.

According to some embodiments, apparatus 24 comprises one or more input devices to enable users to interact with the apparatus 24. The input device can be in the form of a touch screen 36 which can also display content. Alternatively, another touch screen can be provided for user interaction. The input devices can be in the form of a keyboard 38, a controller 40, a card reader 42, a bank note acceptor (BNA) and/or coin acceptor 44, a barcode or ticket scanner 46, or other virtual or physical input device. Apparatus 24 can comprise one or more output devices 48, such as a printer for printing receipts and the like, and one or more loudspeakers. The loudspeakers can be unidirectional loudspeakers for directing audio for a specific channel to a specific area. The input and output devices can be integrated with or connected to the apparatus 24.

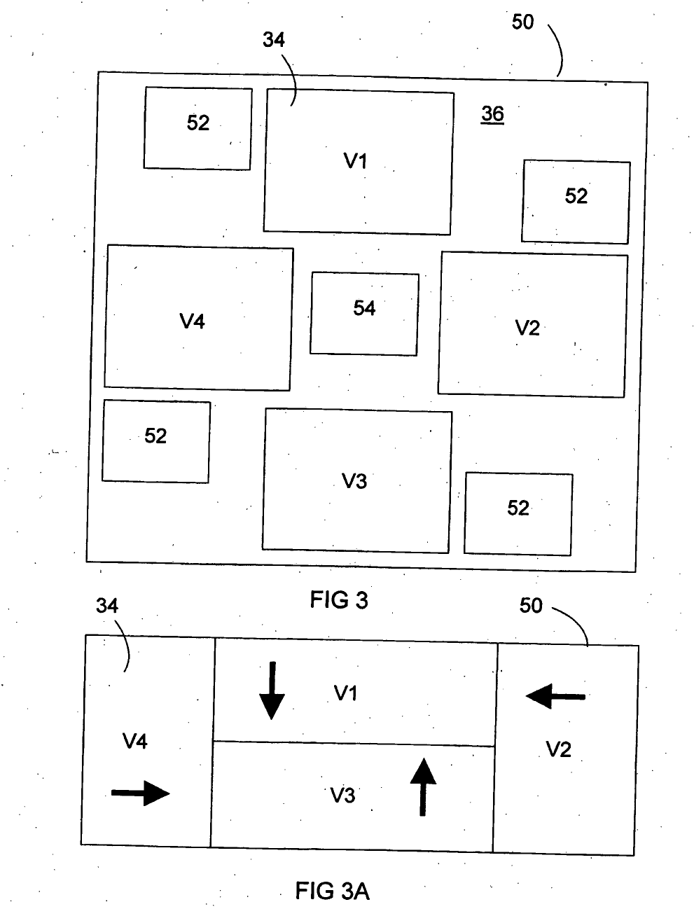

FIG. 3 illustrates an example of another aspect of the present invention, which is in the form of a graphical user interface (GUI) 50 for displaying content supplied from a plurality of sources in a multicast signal. The GUI 50 includes at least one viewing object 34 coupled with one of a plurality of player objects 32, as described above. Each viewing object 34 displays content from the player object 32 with which the viewing object 34 is coupled according to the stream in the multicast stream 21 with which the player object is paired. In the example shown in FIG. 3, the GUI comprises four viewing objects 34, for example to enable four people to watch different content in their respective viewing area.

Whilst FIG. 3 shows viewing objects 34 as substantially square areas, it will be appreciated that they can be any shape. In some embodiments viewing objects 34 can be contiguous such that the viewing objects 34 are tessellated on the touch screen 36, as shown in FIG. 3A, rather than spaced apart as shown in HG 3. It will also be appreciated that viewing objects 34 can be oriented in any desired orientation as required. For example, where the apparatus is wall mounted, the viewing objects 34 can be in the same orientation. Where apparatus 24 is in the form of tabletop display 24A, viewing objects 34 can be oriented such that content is displayed in the correct orientation for a user located on each respective side of the tabletop display 24A, as indicated by the arrows in FIG. 3A.

The GUI 50 includes at least one user input field 52 to receive input from a user. Via the input field 52, the user can change the source of the content being displayed in their respective viewing area by their respective viewing object, i.e. effectively switch channels. As described above, switching channels is achieved by coupling the viewing object to a different player object to cause the viewing object to display content from a stream paired with the different player object. In the example shown in FIG. 3, the GUI comprises four input fields 52, one input field associated with each viewing object 34. In this example, the input fields 52 are shown separately from their associated viewing areas. However, in alternative embodiments, the input field can be displayed with the viewing area. In some embodiments, the input field 52 displays virtual arrows to change the channel up or down and/or a virtual number pad to enable the user to key in a channel number.

According to some embodiments, GUI 50 includes at least one field 54 for displaying information relating to content displayed by one or more of the at least one viewing objects 34. For example, performance statistics and/or betting odds relating to a sports event displayed by at least one of the viewing objects 34 can be displayed in field 54. Whilst FIG. 3 shows a single field 54 located centrally in the GUI 50, GUI can comprise multiple fields 54, for example, with one field 54 associated with each viewing object 34.

Alternatively, one or more fields 54 can appear within viewing objects 34. In other embodiments, the related information can be displayed in an overlay above the content to which it relates such that the information can be viewed without obscuring the content beneath.

According to some embodiments, field 54 also enables users to select content, and for example place a wager. For example, a user can view betting odds in field 54 relating to a race being displayed in their respective viewing area. Via input field 54, the user can select one of the contenders, e.g. a horse, enter a stake, e.g. $10 and select a wager format, e.g. win, place, trifecta etc. The user can pay for the wager via card reader 42 or bank note acceptor (BNA) 44 and communications network 28 for connection to the relevant financial institution to authorize payment. A receipt for the wager can be printed by printer 48.

Meanwhile, other users can watch different content in other viewing areas. For example, another user can watch a grand prix or the like and select the desired viewing angle, e.g. in car with the user's favoured driver.

In some embodiments, users can view food and drink menus for the venue in which the present invention is situated, order and pay for their selections via GUI 50 using viewing objects 34, field 54, card reader 42 or bank note acceptor (BNA) 44, communications network 28 and printer 48. Such additional content can be provided by content management module 30 coupled to be in communication with the server 20 or can be provided by an in-house television source.

Where apparatus 24 is in the form of a table top display 24A, apparatus 24A comprises a touch screen 36, a large LCD screen and a layer of toughened safety glass. Table top display 24A can also comprise one or more overlayers as required. Table top display 24A can replace conventional tables and are particularly suited for a group of people such that each user can occupy one side of the table top display and view content of their choice on their own viewing object 34.

For individuals or smaller groups, a bar top or desk top display 24B having the same functionality, but in a smaller device, can be used. Alternatively, individuals can be provided with a display tablet 24C having the same functionality, for example, as a substitute for a menu, which the user can take to their table or with which the user can move around the venue.

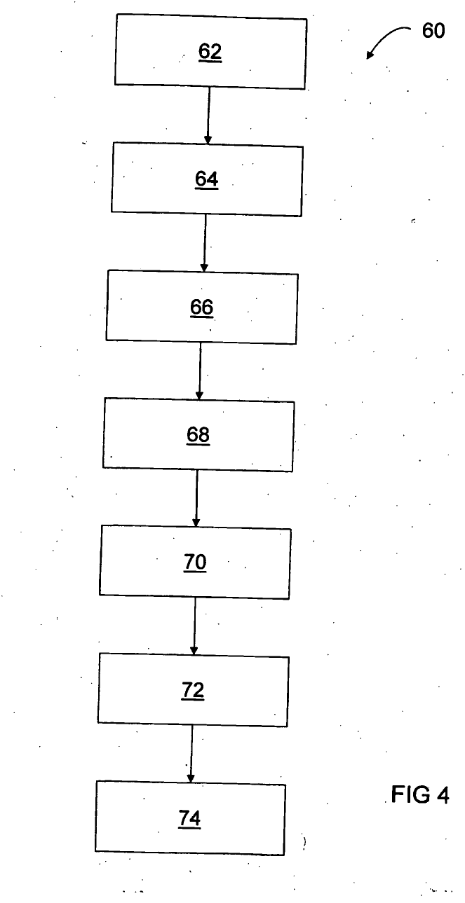

Referring to the general flow diagram of FIG. 4, another aspect of the present invention is a method 60 for managing content supplied from a plurality of sources in respective signals, such as, but not limited to free to air television, video on demand (VOD), satellite television, web browser content, such as content from a specific website, static content, content management systems 30 etc., as described above. In some embodiments, such methods 60 can include at step 62 server 20 receiving modulated RF signal 18 from modulator 16.

The method 60 includes at step 64 server 20 transcoding one or more of the signals and/or resizing content in the signals as required.

At step 66, method 60 includes combining the transcoded and/or resized signals into the multicast stream 21.

At step 68, method 60 includes splitting the multicast stream 21 comprising the plurality of streams representing the signals into the constituent streams.

The method 60 includes at step 70 pairing a player object 32 with each constituent stream.

The method 60 includes at step 72 coupling a viewing object 34 with one of the player objects 32 to display content from the stream paired with the respective player object.

The method 60 further includes at step 74 switching a signal displayed by the viewing object 34 by coupling the viewing object with a different player object.

It will be appreciated that server 20, master control server 26 and apparatus 24 can comprise storage media in the form of memories comprising computer readable media. The computer readable media comprise computer readable program code components, at least some of which are selectively executed by respective processors to cause the execution of embodiments of the present invention described herein.

It should be appreciated that use of the term “multicast” in this specification is intended to refer to any stream comprising signals from a plurality of sources.

Hence, the systems, methods, apparatus and user interfaces according to embodiments of the present invention thus address or at least ameliorate the aforementioned problems of the prior art by pairing player objects 32 with respective streams of the multicast stream 21 and coupling a viewing object 34 in an apparatus 24 with one of the player objects to display the content from the respective stream. Therefore, embodiments of the present invention enable users to switch between streams without the latency of switching experienced with prior art systems, methods and apparatus. Multiple viewing objects 34 in a single apparatus 24 enable users to view multiple streams simultaneously.

Embodiments of the present invention thus benefit users and society as a whole by facilitating efficient transmission, display and manipulation of content from multiple sources, such as free to air, cable and satellite television signals. Embodiments of the present invention as described herein also provide enhanced user experiences and more social interactions, thus encouraging users to visit a venue in which an embodiment of the present invention is installed, stay longer in the venue and therefore spend more money in the venue, thus contributing to the economic benefit of the venue and of each country in which the invention is implemented.

In this specification, the terms “comprises”, “comprising” or similar terms are intended to mean a non-exclusive inclusion, such that an apparatus that comprises a list of elements does not include those elements solely, but may well include other elements not listed.

In this specification, references to prior art are not intended to indicate or suggest that such prior art forms part of the common general knowledge.

Throughout the specification the aim has been to describe the invention without limiting the invention to any one embodiment or specific collection of features. Persons skilled, in the relevant art may realize variations from the specific embodiments that will nonetheless fall within the scope of the invention.

1. A method for managing content supplied from a plurality of sources in respective signals, the method including:
splitting a multicast stream comprising a plurality of streams representing the signals into the constituent streams;
pairing a player object with each constituent stream; and
coupling a viewing object with one of the player objects to display content from the stream paired with the respective player object.

2. The method of claim 1, further including switching a stream displayed by the viewing object by coupling the viewing object with a different player object.

3. The method of claim 1, further including transcoding one or more of the signals and/or resizing content prior to combining the signals into the multicast stream.

4. An apparatus for managing content supplied from a plurality of sources in a multicast stream, the apparatus including:
a plurality of player objects, each player object paired with a constituent stream of the multicast stream; and
at least one viewing object coupled with one of the player objects to display content from the stream paired with the respective player object.

5. The apparatus of claim 4, including a plurality of viewing objects capable of simultaneously displaying content from a stream paired with the respective player object with which the viewing object is coupled.

6. The apparatus of claim 4, wherein the apparatus is in the form of one or the following: a tabletop display; a bar top display; a desk top display; a display tablet.

7. The apparatus of claim 4, wherein the apparatus comprises one or more physical or virtual input devices.

8. The apparatus of claim 7, wherein the input device is one or more of the following: a touch screen; a keyboard; a controller; a card reader; a bank note acceptor; a coin acceptor; a barcode scanner; a ticket scanner.

9. The apparatus of claim 4, wherein the apparatus comprises one or more of the following output devices: a printer; a loudspeaker; a unidirectional loudspeaker.

10. The apparatus of claim 5, wherein the plurality of viewing objects are tessellated on a touch screen.

11. The apparatus claim 5, of wherein the plurality of viewing objects are oriented for a user on a respective side of a touch screen.

12. A system for managing content supplied from a plurality of sources in respective signals, the system including:
a server for transmitting a multicast stream comprising streams representing the signals from the plurality of sources;
one or more apparatus coupled to be in communication with the server and subscribing to the multicast stream;
wherein each apparatus includes:
a plurality of player objects, each player object paired with a constituent stream of the multicast stream; and
at least one viewing object coupled with one of the player objects to display content from the stream paired with the respective player object.

13. The system of claim 12, further including a master control server coupled to be in communication with the server via a communications network.

14. The system of claim 12, further including a content management module coupled to be in communication with the server, preferably via the master control server, to provide additional content to the apparatus.

15. The system of claim 12, wherein the server is an IPTV server.

16. A graphical user interface for displaying content supplied from a plurality of sources in a multicast stream, the interface including.
at least one viewing object coupled with one of a plurality of player objects to display content from the player object, each player object paired with one of the streams in the multicast stream; and
at least one user input field to receive input from a user to couple the at least one viewing object to a different player object to cause the viewing object to display content from a stream paired with the different player object.

17. The user interface of claim 16 , further including at least one field for displaying information relating to content displayed by the at least one viewing object.

18. The user interface of claim 17, wherein the information relating to content displayed by the at least one viewing object includes performance statistics and/or betting odds relating to a sports event displayed by the at least one viewing object.

19. The user interface of claim 16, comprising a plurality of viewing objects.
